(19) United States
(12) Patent Application Publication
(10) Pub. No.: US 2003/0216960 A1
(43) Pub. Date: Nov. 20, 2003

(54) System and method for offering geocentric-based incentives and executing a commercial transaction via a wireless device

(76) Inventor: Richard Postrel, Miami Beach, FL (US)

Correspondence Address: ANTHONY R BARKUME, 20 GATEWAY LANE, MANORVILLE, NY, 11949, US

(21) Appl. No.: 10/147,439

(22) Filed: May 16, 2002

(51) Int. Cl. G06F 17/60

(52) U.S. Cl. 705/14

(57) ABSTRACT

A system and method of obtaining geocentric or location-specific information over a cellular telephone connection. A user enters an information access code into his remote device, which has cell phone capability and a GPS receiver, which sends an incentive request(including the access code, a user identification code, and GPS location data) to an information server via the cellular network. The information server uses the request to retrieve an incentive record as a function of the access code and the GPS location data, and then transmits the incentive record back to the remote device via the cellular telephone network. The remote device provides the incentive record to the user via a user interface such as a display screen. The incentive record will have information related to a merchant offering the incentive for a product of interest to the user that is located in a vicinity of the remote device, since the information server is aware of the location of the user due to the GPS data it receives.

### BACKGROUND OF THE INVENTION

The present invention relates to the providing of information, product or service advertisements, offers and purchase incentives and consummation of commercial transactions based on the location and/or identity of a user utilizing a wireless remote device incorporating a cellular telephone.

Mobile commerce, also known as m-commerce, is a form of e-commerce that allows merchants and vendors to execute transactions with customers via a mobile device such as a handheld PDA, cell phone, and the like. Many PDAs are web-enabled and contain cellular modems that enable the user to connect to a web site, request information about a product or service, and then consummate a purchase if so desired. In this context, the mobility of the wireless PDA allows the user to move about untethered from a PC. However, these mobile web-devices do not provide any added-value or personal tailoring of information beyond what is conventionally done over the web; in particular, they do not allow a merchant to provide information and other purchase incentives to a mobile user that is based on his location at the time the transaction (or information request) is made.

Likewise, incentive or coupon systems are prevalent today, and generally consist of a merchant or distributor mailing or otherwise distributing (e.g. through newspaper inserts) incentives to potential customers on a mass basis. Although systems have been suggested that allow web sites to offer downloadable coupons, these coupons are generally printed out and then taken by the customer to the merchant's physical location for redemption. Again, there exists no mechanism in these prior art system for providing purchase coupons or other incentives to users that are based on and tailored to their location at the time the incentive is offered. Such a location-specific offering would be highly advantageous since it would allow merchants to provide incentives that the customer is much more likely to use at the time the exchange is made since it based on his location.

With respect to these mobile devices, remote wireless devices such as dedicated cellular telephones or handheld personal digital assistants (PDAs) that incorporate cellular telephone capabilities are utilized by numerous people throughout the world. These remote devices enable a user to dial a cellular network and connect with other users, voice mail systems, and remote computers, by use of direct voice contact, interactive voice response (IVR) technology, direct command input on the keypad, and the like. As described above, many remote devices enable a user to communicate in a limited manner to host computers on the Internet that support one or more of the various remote protocols such as web clippings, etc.

It is therefore desired to be able to provide a remote device user such as a cell phone caller with information regarding products and/or services that is specifically tailored to the location that the user is calling from. It is desired to provide such information automatically and in a seamless manner so that the caller does not have to enter his location, and in fact may not even be aware of where he is at the time of the call. It is further desired to provide the information in an interactive manner; i.e. where an initial amount of information is provided and the user is given selectable options for obtaining further information. Finally, it is desired to be able to provide discount “coupons” or other types of purchase incentives and added value offers that may be usable by the caller immediately or at a nearby establishment.

It is also desired to provide such a method and system that will enable users to dial a preconfigured number from their cellular phone device, regardless of the cell from which they are calling, and obtain the same type of information based on the number dialed, which is varied based on the cell they are calling from. It is desired to provide cellular operators with the ability to provide advertising and other types of geocentric or location-specific information and obtain additional, incremental revenue from sponsors based on a customer response event such as consummation of a sale, a direct product/service inquiry, or other customer/merchant interaction, that originates with an advertisement or incentive provided by the cellular operator.

It is desired to provide merchants and sponsors with increased business opportunities attainable through the delivery to users of geocentric information via the cellular network, wherein the merchant only pays for such information delivery upon a customer response event caused by such information delivery.

U.S. Pat. No. 6,026,375, METHOD AND APPARATUS FOR PROCESSING ORDERS FROM CUSTOMERS IN A MOBILE ENVIRONMENT, relates to a system that enables service providers to receive an order from a mobile customer, receive customer location information from a location determination system, and schedule the completion of the customer's order to coincide with the customer's arrival at a local facility able to satisfy the customer's order. In one embodiment, the mobile customer is associated with a tracking device connected to a mobile location determination system that determines the customer's location, which is then given to the service provider. The service provider uses the customer's location to determine a local facility that can satisfy the customer's order. The service provider transmits the order to the local facility and schedules the fulfillment of the order to coincide with the customer's arrival at the local facility. The service provider also may maintain a database of customer transactions that can be used to determine customer preferences. This system relates only to a customer placing orders with a system via the mobile unit; this system does not allow the customer to inquire about various types of information on various types of services he may be interested in, and then make an independent selection of an establishment that he may want to visit and conduct business with based on an incentive offering by the system.

U.S. Pat. No. 6,343,317, INTERNET SYSTEM FOR CONNECTING CLIENT-TRAVELERS WITH GEOGRAPHICALLY-ASSOCIATED DATA, is for a system for delivering position-related information from a data repository to a user, which includes a computerized appliance for receiving and reporting the position-related information to the user, a data repository remote from the appliance for storing information related to the position of the computerized appliance, a system for determining the position of the appliance, and a wireless communication link between the data repository and the appliance. The position-determining system tracks the position of the appliance, and the information is selected and provided to the appliance from the data repository based on the determined position. In one embodiment, position is determined by a GPS system integrated with the appliance, and information is selected by an Internet service and sent to the appliance based on the reported position, via a cellular telephone Internet link between the server and the appliance. This system does not provide for transactions to be consummated by the user directly with local merchants after being provided with purchase incentives via the system, wherein the incentive acceptances by the user are communicated to the local merchant and traffic is driven to the premises of the local merchant as a result of the incentive-providing system.

Thus, deficiencies in the prior art are overcome by the present invention as more fully described and claimed herein.

### SUMMARY OF THE INVENTION

In accordance with the present invention, provided is a system and method for executing a geocentric-based transaction with a mobile user. To configure the system, a database is assembled at an information server, the database having a plurality of incentive records, and each incentive record including a product identifier, an incentive offering for the product indicated by the product identifier, and a merchant identification comprising the name and location of a merchant providing the incentive offering for the product indicated by the product identifier. The information server receives an incentive request from a user on a cellular telephone, the request including an access code entered by a user into the cellular telephone, in which the access code is indicative of a product desired to be obtained by the user, and location data indicative of the location within the cellular network from which the cellular telephone has connected. The location data may be obtained from the cellular network or it may be obtained from the cell phone, for example by using a global positioning satellite (GPS) device.

The information server processes the incentive request to retrieve from the database an incentive record as a function of the access code and the location data, and then transmits the retrieved incentive record to the remote device via the cellular telephone network. The remote device provides the incentive record to the user via its user interface, and the user executes a transaction directly with the merchant identified in the incentive record based on the incentive offering in the incentive record.

In particular, the information server processes the incentive request by analyzing the access code to determine the type of product requested by the user, analyzing the location data to determine the location of the cellular telephone, and querying the database to retrieve at least one incentive record in which the product identifier matches the type of product requested by the user and in which the merchant location is within a predetermined distance from the location of the cellular telephone.

The incentive request may further include an identification of the user. Further, the information server may transmit a request confirmation to a merchant computer associated with the merchant identified in the incentive record, the request confirmation including the identification of the user and an indication of the incentive record transmitted by the information server to the user. In this case, at the time of the transaction, an identification of the user requesting the transaction is matched with the request confirmation transmitted by the information server as a condition for providing the incentive in the transaction.

The merchant computer may directly modify the incentive record at the information server to change the incentive as desired by the merchant, even after the system has been configured. A database of information may be compiled with an indication of users who have made incentive requests, the incentive offerings they have received, and the incentive offerings they have utilized in transactions.

A selection menu may optionally be transmitted by the information server to the cellular telephone, which includes a plurality of choices relevant to the type of product requested by the user, and then the user selects at least one item from the selection menu and transmits the selection back to the information server. The information server then uses the selection to further query the database to retrieve at least one incentive record in which the product identifier matches the selection made by the user.

The user may specify the predetermined distance that the merchant location may be from the location of the cellular telephone. The user may also specify a price criteria which is utilized by the information server in processing the incentive request.

Thus, for example, a user could press a system access code such as #22 on his cell phone, and once access into the system is made, then follow voice or text prompt instructions such as “Press 1 for restaurants,” and the information server would look up a list of restaurants in the same location as the user (determined by the GPS data), and then send a list of the restaurants, menus, etc. The user could depress cell phone keys or the touchscreen of the remote device, and further information such as a detailed menu and prices could be provided. A discount incentive or other value-added item could also be provided on the display, where the caller would optionally accept the item by pressing the screen. The discount information, as well as the identity of the caller, would then be forwarded to the participating establishment. When the caller arrives at the establishment, he would be given the discount or other purchase incentive based on a showing of his identity to match with the coupon. The use of a credit card in conjunction with this invention is envisioned, which of course would provide proof of the caller's identity to the merchant. In addition, the credit card may be used for online purchases of geocentric services or information, whereby the caller may indicate acceptance of an offer without having to physically travel to the establishment. A joint marketing effort may be made between the cellular provider and the credit card company for synergistic effects hereunder.

As a result of this invention, users are provided with geocentric information regarding products and/or services that is specifically tailored to the location that the user is calling from, in a seamless manner so that the caller does not have to enter his location data. Cellular operators are provided with the ability to provide advertising and other types of geocentric or location-specific information and obtain additional, incremental revenue from sponsors based on a customer response event that originates with an advertisement or incentive provided by the cellular operator, and merchants benefit by increased business opportunities attainable through the delivery to users of location-specific information via the cellular network, wherein the merchant only pays for such information delivery upon a customer response event (such as consummation of a purchase) caused by such information delivery. Concierge services may be provided to travelers over the cellular network without having to physically visit a particular establishment and without having to input (or even know) their location into the system. Emergency services may also be provided by this invention, for example in the case where a caller is injured and requires an ambulance but does not know his location; in this case, pressing a predetermined emergency number would enable a cellular operator to immediately dispatch emergency services to aid the caller.

### BRIEF DESCRIPTION OF THE DRAWING

FIG. 1 is a block diagram of the preferred embodiment of the present invention;

FIG. 2 is a block diagram of the information server used in FIG. 1;

FIG. 2A is an illustration of the incentive database;

FIG. 3 is an illustration of a PDA remote device with a display screen showing a menu obtained in accordance with the present invention;

FIG. 4 is a flowchart of the operation of the invention wherein the location is determined by the cell network;

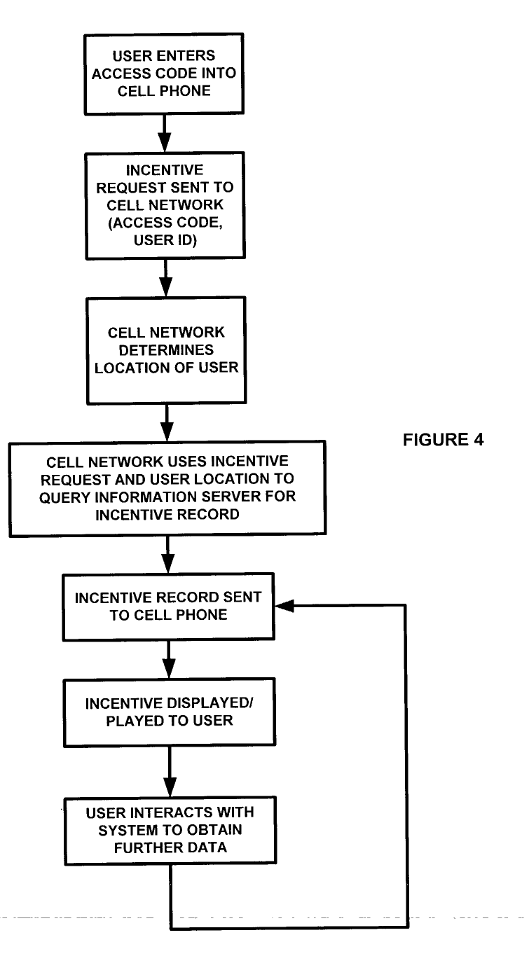

FIG. 5 is a flowchart of the operation of the invention wherein the location is determined by the cell phone using a GPS receiver; and

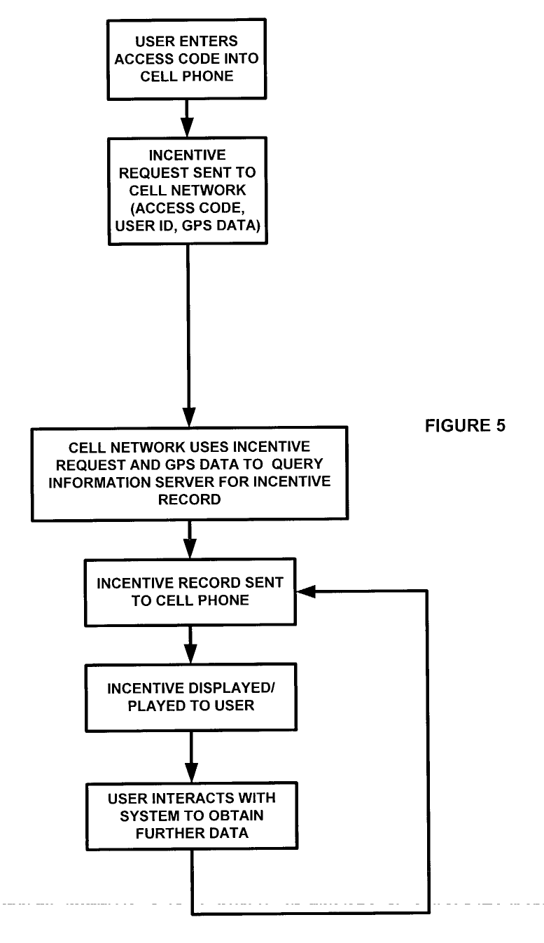

FIG. 6 is a flowchart of the purchase discount provided by the present invention.

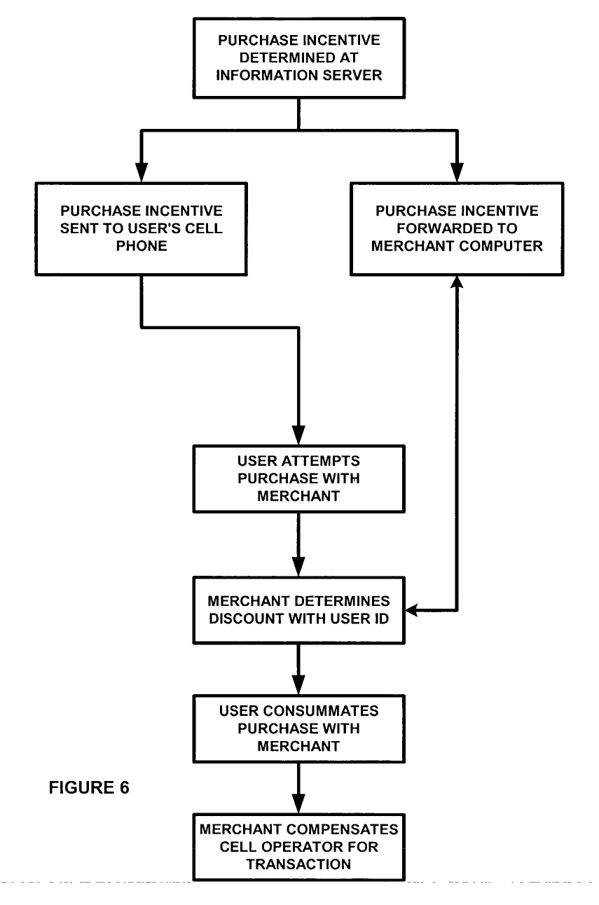

### DETAILED DESCRIPTION OF THE PREFERRED EMBODIMENT

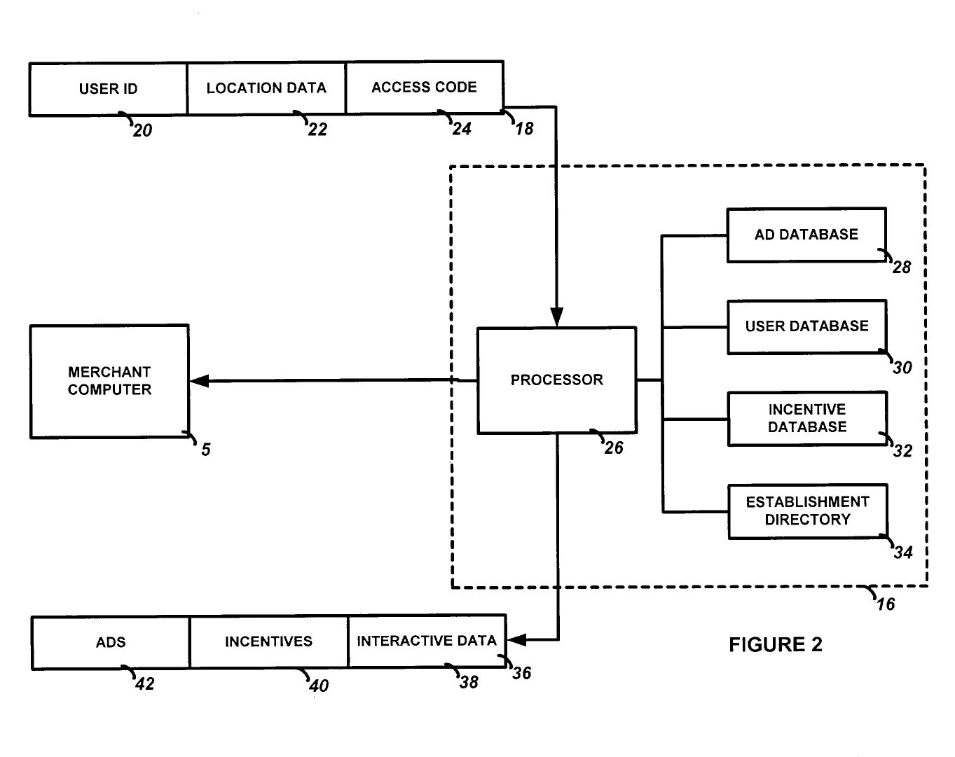

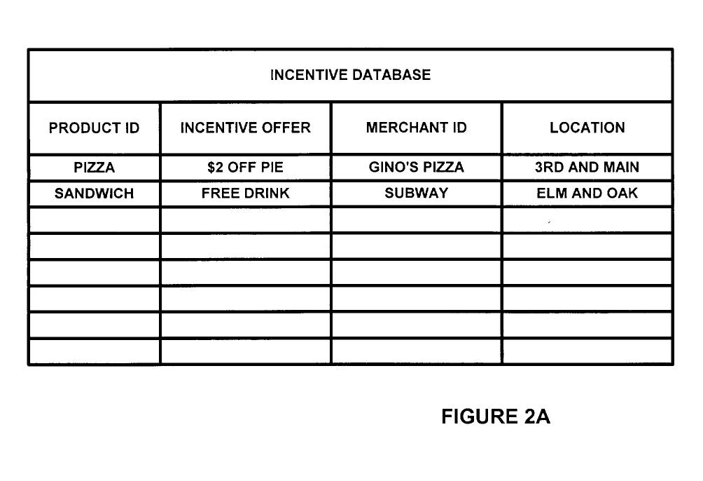

With reference to the Figures, the preferred embodiment of the present invention will now be explained. An information server 16 is initially configured with an incentive database 32 of incentive records, by populating the database with incentives from various merchants desiring to take advantage of the system, as shown in FIG. 2A. That is, many different types of merchants offering many different types of products and services can subscribe to the cellular operator's system in order to generate increased traffic and revenue. The information server may reside with the cellular operator's network, or it may be a separate server computer hosted on the Internet. Each participating merchant provides to the information server 16 one or more incentive records, each comprising at a minimum the identification of a product or product type, an incentive offering related to that product, and an identification of the merchant which will include both the name of the merchant as well as an indication of the merchant's location. That location information as well as the product identification will be utilized by the system when an incentive request is made by the user as described herein. The database, which may be comprised of several interacting databases as well known in the art, may be distributed amongst various servers. The database(s) will contain a multiplicity of records of varying types of products in various locations.

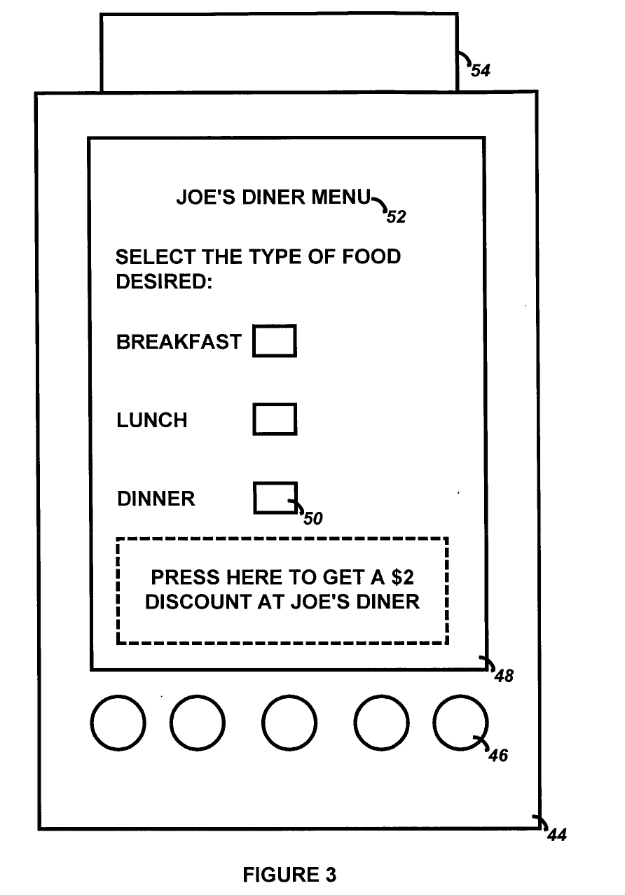

A remote device 1 is carried by a user, and includes at least a cell phone 2, a GPS receiver 6 (optional), and a user interface 4. The remote device may be a handheld PDA with a touchscreen user interface, as shown in FIG. 3, with additional optional GPS module 6 and cell phone module 2 as known in the prior art. In the alternative, the remote device 1 may be a cell phone with an associated GPS receiver attached to it, either via a battery upgrade or the like, as known in the art. In this case, the user interface 4 would be a standard telephone keypad, microphone and speaker as found in the cell phone. Use of artificial intelligence (AI) is contemplated in conjunction with interactive voice response (IVR) technologies as well.

The GPS receiver 6 communicates as well known in the art with a GPS satellite 8 in order to provide location data that indicates with specificity the location of the person carrying the remote device 1. The GPS system is quite accurate and will provide the invention with data that will enable it to provide the geocentric or location-specific information as explained below.

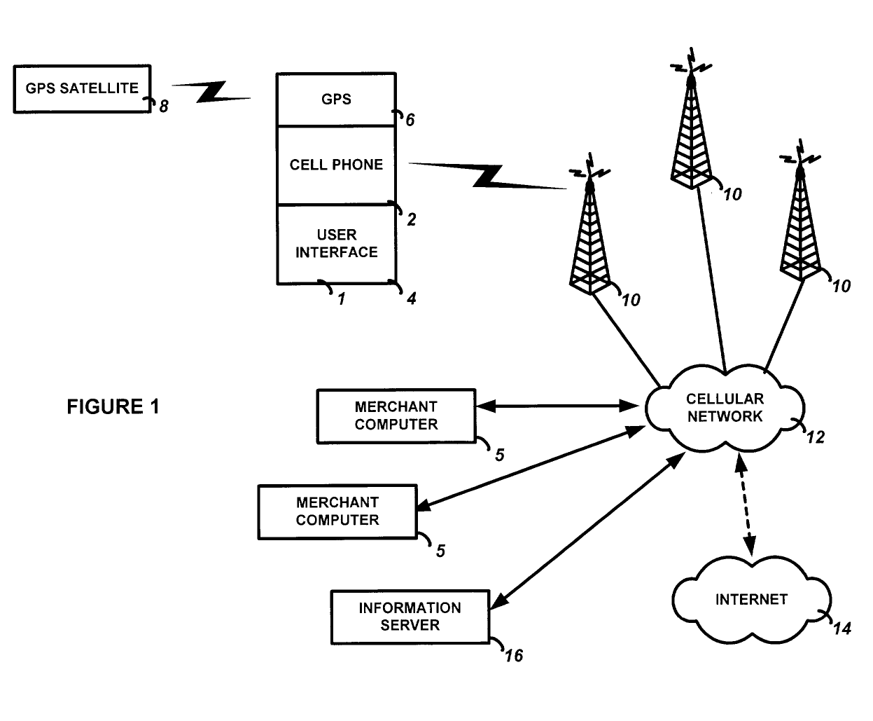

To use the system, the caller will press a pre-configured information access code 24 into the cell phone keypad, such as #22, which will be assembled into an incentive request 18 (shown in FIG. 2) and sent via wireless connection to the closest cell antenna 10 in the cellular network. In the alternative, the caller may be able to speak into the cell phone and a voice recognition program decodes the spoken access code for inclusion into the incentive request. The incentive request 18 will also include a user identification code 20 and the location data 22 obtained from the GPS system. The user identification code may be simply the ID of the cell phone, such as a serial number or the cell phone number. The cellular network 12 will then communicate the incentive request 18 to an information server 16, which may be interconnected to the Internet 14 as shown in FIG. 1. In the alternative, the information server may be directly associated with the cellular network 12 so that access to the Internet 16 is not required.

The information server 16 will use a processor 26 to process the incentive request by examining the location data 22 and the access code 24, and optionally the user identification code 20. The processor will then refer to the various databases shown in FIG. 2; the advertisement database 28, the user database 30, the incentive database 32 previously described, and/or the establishment directory 34. The processor will serve a main menu, which will give the user various options, e.g. “Press 1 for local restaurants, press 2 for local hotels, etc. The user responds by pressing the desired key, for example the “1” key for restaurants, and the processor will interpret the request and obtain a list of the restaurants closest to his location as indicated by the GPS location data 22. The processor will query the establishment directory and/or the incentive database 32 for this information, and then obtain the closest match or matches for transmission back to the caller. Search criteria may also be variable and change in real-time as indicated by the caller (e.g. distance or price criteria as explained below). The user ID may be logged in the user database 30 for billing or other record-keeping purposes. The user database may also store a user profile that will be used by the processor to generate the incentive record 36, for example by determining what types of restaurants that user generally prefers and only returning information about such types (e.g. diners as opposed to expensive restaurants). The user profile could also contain information about the remote device 1 that the user may have preregistered with the system so that the processor will be able to ascertain the type of data to return to the remote device 1 (e.g. display data, voice data, etc.). Preregistration is not required, since any user would be able to dial into the system and obtain its benefits, even if not a preregistered user. In the case of a first-time or anonymous user, system defaults could be used or queries may be made to the user in real-time to ascertain his or her preferences at the time of data acquisition.

In addition, the processor 26 may refer to the ad database 28 to determine if advertisements 42 relevant to the user and/or his location should be transmitted with the incentive record 36. Likewise, the incentive database 32 may be used to provide incentive data 40 (or other types of purchase incentives) as explained further below. The incentive record 36 is assembled and sent back to the remote device 1 via the cellular network 12.

The remote device 1 receives the incentive record 36 and provides it to the caller via the user interface 1. In the simple case of the cell phone embodiment, the information may be simple text characters such as “JOE'S DINER” flashing across the alphanumeric screen of the cell phone (perhaps with an address of the diner), or it may be a text to voice function that speaks the same information through the cell phone speaker. In the case of a more sophisticated remote device such as the handheld PDA 44 (with GPS module 54) in FIG. 3, the incentive record would be displayed on the touchscreen 48 for viewing by the user. As shown in FIG. 3, this display may include various information as well as options, such as checkboxes 50 to select the desired meal type (breakfast, lunch or dinner). The user would then indicate his response by pressing the screen accordingly, and that information would cue up additional information to be displayed on the screen (such as specific meal choices). Hard buttons 46 may be used for this task as well known in the art.

Navigation tools familiar to most users, such as “Back” or “Forward” buttons as used in most web browsers, may also be implemented to make the user's experience more rewarding and efficient. The “look and feel” of user interfaces known to most people will help in promulgation and extensive use of the system since it would not require the users to learn a completely new interface from scratch. In a simple cell phone case, an interactive voice response (IVR) paradigm may be used, where the caller is instructed to press certain keys on the keypad of the phone to get further information (e.g. “press 1 for a breakfast menu, press 2 for a lunch menu,” etc.).

The user can accept the incentive or coupon (an optional step), and his identification data as well as the incentive information may be transmitted as a request confirmation to the merchant computer associated with the merchant for later redemption. Optionally, a credit card may be used to prepay for the goods and/or services by entering the credit card number into the phone. Additionally, when the caller goes to Joe's Diner, he would present an ID card (or credit card) to establish his ID and a merchant computer 5 at the diner would lookup his discount from the information server, which in this case would be a $2 coupon off of his meal. In the alternative, the incentive data may be transmitted by the information server 16 to the merchant computer 5 at the time it is sent to (and/or accepted by) the user so that the data resides at the merchant computer 5 and the transaction process is expedited when the user arrives at the merchant location. The information service could charge the merchant for providing the incentive and/or ad data to the user, either on a per-hit (or per-click) basis or when the merchant computer confirms the identity of the user at the time of the transaction. A coupon or incentive may be printed out by the user for later use if the remote device has a printer attached.

In an alternative embodiment, the user may be given an option to have his call transferred directly to the merchant of interest. In this case, the system would instruct him to “press 1 to connect the call” or the like.

The embodiment described above provides very specific location data via the accurate GPS system, and thus enables a user to automatically access information from the system that is correlated with his exact location. In an alternative embodiment, the remote device 1 does not use the GPS system, but rather the location data used by the processor will be obtained directly from the cellular network. When the user places the call, the transmission will be picked up by the nearest cell antenna, and that information will be conveyed as location data to the information server 16 as well known in the art. While this embodiment is not as accurate as the GPS embodiment since it may not pinpoint the exact location of the user (but only the location of the cell he is in, which will be comparatively large), it uses a less expensive remote device since the GPS receiver is not needed. This allows a standard pre-existing cell phone to be used with this invention with little or no modifications.

Other embodiments utilizing similar technologies for automatically providing the location of the user of the remote device are also contemplated by this invention.

Benefits are provided from the present invention to the users of the system, to the cellular operators, and to the merchants or sponsors who provide information and advertising to the user via the cellular system. Users benefit greatly since they can obtain desired information regardless of their location throughout the entire cellular network (or group of cooperating networks), without even having to know where they are in the network. Access may be made to a main menu by pressing #22, or by providing a preconfigured access code or listing of codes, the users can access such information in the same manner regardless of their location. Thus, for example, a user would know that no matter where he may be, he can get a list of local restaurants by pressing #222, a list of local business centers by pressing #223, a list of local hotels by pressing #224, and the like, thus bypassing the first part of the main menu. The use of the same codes throughout the cellular network promotes frequent usage since the familiarity of the codes would make the system easier to use. In another paradigm, a single access code is used, and then menu-driven navigation options are presented to the user. Thus, the user would enter #22 to enter the system, and his location data would cause display of a main menu tailored to the location from which the call has been placed. Buttons would be displayed for accessing various types of information, such as “Restaurants”, “Hotels”, “Car Rental Agencies”, and the like. Pressing these buttons would provide further menu items tailored to the type of information being requested. Many different ways of interacting with the user are contemplated by this invention, as long as the user's location information is used as a means of obtaining and providing the appropriate information.

A user could also specify an outer limit of the distance he may be willing to travel to reach a destination, in terms of time or distance. The user could indicate he only wants restaurants within five blocks, or within a five minute drive, etc. The distance criteria could be predetermined in a user profile, or it may be a response to a real-time query from the system after the restaurant access code is pressed, or it may be embedded in the access code itself (e.g. #2223 gets a list of establishments within five blocks, while #2228 gets a list of establishments within eight blocks, etc.).

Likewise, the user could specify a desired price limit to prevent the system from displaying items or establishments that may be too expensive for the user. For example, the user could specify that he wants to see the names of restaurants that have an average priced meal of less than twenty dollars, or hotels with a room available for less than one hundred dollars.

Thus, virtually any type of filter such as the distance/time filter or the price filter could be used to extract subsets of information of particular interest to the user and make his browsing experience more efficient and enjoyable.

The system of the present invention also provides for real-time reviews of establishments available in the listing provided to the user. That is, the user could press a number on the keypad to retrieve a review (or other promotion), which would be played over the cell phone for the user to listen to. The synergy of the voice channel of the cell phone along with the data network capabilities provides this unique opportunity for voice reviews. Simple reviews in the form of display data can also be provided (e.g. one to four stars shown on the display screen). The user can also be provided with the ability to input his own review of the establishment, in real time (or later), by reciting the review into the cell phone after depressing an appropriate predetermined key sequence, or by entering simple data on the keys (such as the aforementioned one to four star rating). A user could access tabulated results, such as “This establishment has received four favorable reviews out of a total of six”, or the like.

Although the term “access code” has been used herein, it is contemplated that the codes required to be entered be made publicly available to all who want to use the system. A subscription level may also be added, wherein certain types of information may only be obtainable via a subscription to the service, or to a premium level of the service. Thus, a user may have to enter a PIN number or the like in addition to the publicly available access code in order to obtain the requested information.

A service such as the purchase of travel insurance may be made available through this system. For example, a user could indicate to the system where he is traveling to, and an appropriate insurance policy may be made available to the user for purchase at that time.

Cellular operators benefit greatly from the system and methods of the present invention. By using the preexisting cellular infrastructure, cellular operators can now become advertisers of products or services and charge the sponsors or merchants accordingly. There is a nominal or at least slight incremental cost to the operators in providing the service to the users. Revenues would be obtained through contracts with local merchants, wherein the cellular operator would only provide their name and address on an agreement to pay for such advertisement delivery by the merchants. The system could be set up so that advertisers pay only on a customer response event such as fulfillment or consummation of a sale that was triggered by an ad or incentive delivered by the cell operator (or even a direct inquiry about a product or service from the merchant), since it is possible to track the activities of a user if and when they complete the customer response event at an establishment that subscribes to the service. Thus, a user would be given a list of restaurants, and then press a key associated with the one he wants to visit. He may be given a coupon or other type of incentive (e.g. “Press 1 to get a free appetizer or glass of wine with dinner”), and the discount or free offer would be registered with the restaurant so that it can be given to the user upon visiting the restaurant and showing his ID. The system would then indicate to the cell operator that the user (1) visited the establishment, and (2) consummated a transaction based on the advertisement delivered by the cell operator. The cell operator would later collect a transaction fee based on this fulfillment. Alternative types of billing schemes could of course be implemented, e.g. flat-fee based, etc.

The merchants that subscribe to this system also benefit greatly from it, in the form of increased traffic and business opportunities provided by the cell operator. Thus, there would be increased advertisement potential at an incremental (i.e. per transaction) cost. The system operates as a global yellow pages with local focus since it delivers location-specific information based on the location of the user in the network.

It is also contemplated that a fixed or landline telephone may be used, for example a pay telephone station, in the same manner as a cellular telephone. In that case, the location information would be derived from the caller-ID information (i.e. the telephone number of the calling phone), since the phone is fixed with respect to its location. It is also contemplated that a user could program a future destination into the system so that he can obtain geocentric information of a place where he is planning to travel. For example, a traveler at an airport could use the system to obtain desired information prior to departing on the plane by entering a code associated with his destination, and then he would obtain the requested information prior to departure.

Various ways of making payments of products or services are contemplated by this invention. For example, it has been mentioned herein that a user may use his credit card to both establish his identity with a merchant (who then retrieves an appropriate discount or other incentive based on the user's identity) as well as pay for the product or service. It is also envisioned that charges may be made by the cellular operator directly to the user's cellular phone bill under certain circumstances. For example, if a user dials an access code to obtain a list of taxi services that service the immediate location of the user, he may pay for the provision of the listing by pressing a key that authorizes payment for the listing on his phone bill. A discount or rebate may optionally be given to the user if he in fact uses the service (for example if he takes a taxi provided by the service). In this example, the cellular operator would also be able to dispatch the taxi directly to the user since the user's location information would of course be provided as part of the information request. A user may optionally enter a destination address or keyword such as the name of a landmark and obtain the desired information.

The merchants and other issuers of value-added components that are provided to the user in accordance with this invention are provided with the ability to revise the incentive data and other such information directly with the information server. The merchants are given permissions on the appropriate information server databases in a manner known in the art so that each can revise only their own data remotely as they see fit. Thus, for example, a hotel chain might change a discount offer on a real-time basis as the availability of rooms change in order to promote further business and fill rooms. The discount might be increased at certain hotels and on certain days when occupancy is low, and this can be advantageously modified whenever the merchant desires. The incentives can be turned off in certain locations only when those hotels fill up, etc.

The present invention also provides the ability to track demographics of the users that are using the system, what they are buying, where they are traveling, etc. This is accomplished since the system will know the identity of any user that accesses the system, what they inquire about, as well as which transactions they execute. This information may be used on a general demographic basis (e.g. gender, age group, and geographic origin), or it may be used on a more user-specific level (name, address), as the case may be. This information may be collated by the information server and used for further marketing purposes, it may be sold to merchants for the same purpose, etc.

An exemplary embodiment is now provided for illustration purposes of the present invention. John Smith is traveling in New York City, where he is unfamiliar with the local restaurants and decides he would like to have a meal as soon as possible. He presses “#222” on the keypad of his GPS-enabled cell phone, which transmits an information request 18 to the cellular network via the nearest cell antenna. The request includes the #222 access code, the GPS location data, as well as the identification of his cell phone. An information server at the cellular network receives the request, determines from the access code #222 that the requester desires a listing of local restaurants and looks up the cell phone identification in the user database. The user database provides the user profile that indicates the requester is John Smith, and he prefers fast-food restaurants. The information server then queries its databases to find a set of restaurants close to John Smith, as determined by the GPS data received with the request, that are flagged as being of the fast-food type. A set of four such restaurants are found, and the name of each is sent back to John Smith's cell phone and played over the speaker as follows: “Press 1 for McDonald's, press 2 for Burger King, press 3 for Wendy's, press 4 for Subway”. (Note that the order of the establishments provided may be random, alphabetical, by distance or price, or a pay-for-placement order (e.g. McDonald's pays for premium placement in the menu), etc.). Enticed by the thought of a subway sandwich for lunch, John Smith presses 4 on his cell phone keypad, and the information server retrieves the address of the Subway restaurant from the databases and sends it to John Smith's cell phone for display and/or playback over his cell phone speaker. The address may be locally stored on the cell phone so that John Smith may refer to it on his route to the restaurant after termination of the call. The information server may also determine a set of directions based on the GPS coordinates and send them to John Smith's cell phone as well.

The information server also determines from its databases that John Smith should be given an offer for a free soda based on his use of the system. The information server sends a message to the cell phone that is also played over the speaker “You will be a given a free soda when you visit the Subway restaurant.” John Smith optionally indicates acceptance of this offer by pressing a key on the keypad, which is logged by the information server in a database. The information server transmits the free soda offer and John Smith's name to the Subway restaurant so he can obtain his free soda when he arrives.

John Smith arrives at the Subway, orders his lunch, says his name, and the clerk at the register looks up his name to determine that he is entitled to a free soda based on his use of the system. The purchase of the lunch and acceptance of the free soda is logged, and the computer at the Subway shop logs a record that a referral fee must be paid to the cellular operator due to the transaction that just occurred.

Many variants on the above scenario as explained through this specification are possible; this illustrative embodiment is provided only to show the basic operation of the system.

I claim:

1. A method for executing a geocentric-based transaction with a mobile user, comprising the steps of:
a) assembling at an information server a database with a plurality of incentive records, each incentive record comprising
(i) a product identifier,
(ii) an incentive offering for the product indicated by the product identifier, and
(iii) a merchant identification comprising the name and location of a merchant providing the incentive offering for the product indicated by the product identifier;
b) the information server receiving an incentive request from a cellular telephone, the cellular telephone comprising a user interface, the request comprising
(i) an access code entered by a user into the cellular telephone, the access code indicative of a product desired to be obtained by the user, and
(ii) location data indicative of the location within the cellular network from which the cellular telephone has connected;
c) the information server processing the incentive request to retrieve from the database an incentive record as a function of the access code and the location data;
d) the information server transmitting the retrieved incentive record to the remote device via the cellular telephone network;
e) the remote device providing the incentive record to the user via the user interface; and
f) the user executing a transaction directly with the merchant identified in the incentive record based on the incentive offering in the incentive record.

2. The method of claim 1 wherein the incentive request further comprises an identification of the user, and further comprising the steps of
the information server transmitting a request confirmation to a merchant computer associated with the merchant identified in the incentive record, the request confirmation comprising the identification of the user and an indication of the incentive record transmitted by the information server to the user;
entering into the merchant computer, at the time of the transaction, an identification of the user requesting the transaction;
matching the user identification entered into the merchant computer with the request confirmation transmitted by the information server as a condition for providing the incentive in the transaction.

3. The method of claim 2 further comprising the step of the merchant computer modifying the incentive record at the information server to change the incentive as desired by the merchant.

4. The method of claim 2 further comprising the step of compiling a database of information indicative of users who have made incentive requests, the incentive offerings they have received, and the incentive offerings they have utilized in transactions.

5. The method of claim 1 wherein the step of the information server processing the incentive request to retrieve from the database an incentive record as a function of the access code and the location data comprises the steps of
analyzing the access code to determine the type of product requested by the user,
analyzing the location data to determine the location of the cellular telephone; and
querying the database to retrieve at least one incentive record in which the product identifier matches the type of product requested by the user and in which the merchant location is within a predetermined distance from the location of the cellular telephone.

6. The method of claim 4 further comprising the steps of
transmitting a selection menu to the cellular telephone, the selection menu comprising a plurality of choices relevant to the type of product requested by the user;
the user selecting at least one item from the selection menu and transmitting said selection back to the information server; and
the information server using the selection to further query the database to retrieve at least one incentive record in which the product identifier matches the selection made by the user.

7. The method of claim 4 further comprising the steps of the user specifying the predetermined distance that the merchant location may be from the location of the cellular telephone.

8. The method of claim 4 further comprising the step of the user specifying a price criteria, and wherein the price criteria is utilized by the information server in processing the incentive request.

9. The method of claim 1 wherein the the user enters the access code into the cellular telephone by pressing a sequence of keys into a keypad that is part of the user interface.

10. The method of claim 1 wherein the user enters the access code into the cellular telephone by speaking into the cellular telephone and a voice recognition program that is part of the user interface decoding the spoken access code for inclusion into the incentive request.

11. The method of claim 1 wherein the information server is a host computer connected to a global computer network.

12. The method of claim 1 wherein the information server is associated with the cellular telephone network.

13. The method of claim 1 wherein the incentive record is accepted by the user pressing a key on the user interface of the cellular telephone, and an incentive acceptance message is transmitted to the information server as a result of the user pressing the key.

14. The method of claim 1 wherein the location data indicative of the location within the cellular network from which the cellular telephone has connected is derived from the cellular network.

15. The method of claim 1 wherein the location data indicative of the location within the cellular network from which the cellular telephone has connected is derived from a GPS device associated with the cellular telephone.

16. A system for executing a geocentric-based transaction with a mobile user, comprising:
a) a cellular telephone comprising:
a user interface,
means for transmitting an incentive request, the request comprising (i) an access code entered by a user into the cellular telephone, the access code indicative of a product desired to be obtained by the user, and (ii) location data indicative of the location within the cellular network from which the cellular telephone has connected;
b) an information server comprising:
a database populated with a plurality of incentive records, each incentive record comprising
(i) a product identifier,
(ii) an incentive offering for the product indicated by the product identifier, and
(iii) a merchant identification comprising the name and location of a merchant providing the incentive offering for the product indicated by the product identifier;
means for receiving the incentive request from the cellular telephone;
processing means for processing the incentive request to retrieve from the database an incentive record as a function of the access code and the location data; and
means for transmitting the retrieved incentive record to the remote device via the cellular telephone network.

17. The system of claim 16 wherein the incentive request further comprises an identification of the user, and wherein system further comprises a merchant computer associated with the merchant identified in the incentive record, and wherein the information server further comprises means for transmitting a request confirmation to the merchant computer, the request confirmation comprising the identification of the user and an indication of the incentive record transmitted by the information server to the user; and further wherein the merchant computer comprises means for entering, at the time of the transaction, an identification of the user requesting the transaction; and means for matching the user identification entered into the merchant computer with the request confirmation transmitted by the information server as a condition for providing the incentive in the transaction.

18. The system of claim 17 further comprising means for the merchant computer to modify the incentive record at the information server to change the incentive as desired by the merchant.

19. The system of claim 17 further comprising means for compiling a database of information indicative of users who have made incentive requests, the incentive offerings they have received, and the incentive offerings they have utilized in transactions.

20. The system of claim 16 wherein the processing means further comprises means for analyzing the access code to determine the type of product requested by the user, means for analyzing the location data to determine the location of the cellular telephone; and means for querying the database to retrieve at least one incentive record in which the product identifier matches the type of product requested by the user and in which the merchant location is within a predetermined distance from the location of the cellular telephone.

21. The system of claim 19 further comprising means for transmitting a selection menu to the cellular telephone, the selection menu comprising a plurality of choices relevant to the type of product requested by the user; means for the user to select at least one item from the selection menu and transmit said selection back to the information server; and wherein the information server further comprises means for using the selection to further query the database to retrieve at least one incentive record in which the product identifier matches the selection made by the user.

22. The system of claim 19 further comprising means for the user to specify the predetermined distance that the merchant location may be from the location of the cellular telephone.

23. The system of claim 19 further comprising means for the user to specify a price criteria, and wherein the information server further comprises means for utilizing the price criteria in processing the incentive request.

24. The system of claim 16 wherein the user enters the access code into the cellular telephone by pressing a sequence of keys into a keypad that is part of the user interface.

25. The system of claim 1 wherein the user enters the access code into the cellular telephone by speaking into the cellular telephone and a voice recognition program that is part of the user interface decoding the spoken access code for inclusion into the incentive request.

26. The system of claim 16 wherein the information server is a host computer connected to a global computer network.

27. The system of claim 16 wherein the information server is associated with the cellular telephone network.

28. The system of claim 16 wherein the incentive record is accepted by the user pressing a key on the user interface of the cellular telephone, and an incentive acceptance message is transmitted to the information server as a result of the user pressing the key.

29. The system of claim 16 wherein the location data indicative of the location within the cellular network from which the cellular telephone has connected is derived from the cellular network.

30. The system of claim 16 wherein the location data indicative of the location within the cellular network from which the cellular telephone has connected is derived from a GPS device associated with the cellular telephone.
